(19) United States
(12) Patent Application Publication
(10) Pub. No.: US 2007/0139968 A1
(43) Pub. Date: Jun. 21, 2007

(54) Light guide plate and backlight module using the same

(75) Inventor: Chia-Huang Chang, Tu-cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/502,219

(22) Filed: Aug. 10, 2006

(30) Foreign Application Priority Data
Oct. 28, 2005 (TW) 94137871

(51) Int. Cl. F21V 8/00

(52) U.S. Cl. 362/621

(57) ABSTRACT

A light guide plate (10) includes a light incident surface (12), a light emitting surface (14) and a bottom surface (16). The light emitting surface adjoins the light incident surface. The bottom surface faces towards an opposite direction of the light emitting surface. A number of first microstructures (121) and at least a second microstructure (122) are formed on the light incident surface. The second microstructure intersects the first microstructures.

### TECHNICAL FIELD

The present invention generally relates to light guide plates and backlight modules using the same.

### BACKGROUND

Most liquid crystal display (LCD) devices are passive devices in which images are displayed by controlling an amount of light inputted from an external light source. Thus, a separate light source (for example, backlight module) is generally employed for illuminating an LCD panel.

Generally, backlight modules includes a light source, a light guide plate, a reflective sheet, and a diffusion sheet. The light guide plate includes a light incident surface, a light emitting surface adjoining the light incident surface, and a bottom surface facing an opposite direction of the light emitting surface. The light source is located adjacent to the light incident surface of the light guide plate. The light guide plate is located between the reflective sheet and the diffusion sheet with the bottom surface adjacent to the reflective sheet and the light emitting surface adjacent to the diffusion sheet. When light rays produced by the light source are emitted into the light guide plate, the light guide plate redirects the light rays. The light rays from the light source projected towards the reflective sheet are reflected towards the light guide plate to increase utilization efficiency of light energy. The diffusion sheet diffuses the light rays emitted from the light emitting surface of the light guide plate, thus, a brightness of the light incident on the LCD panel would be more uniform.

A typical light guide plate includes a light incident surface, a light emitting surface adjoining the light incident surface, and a bottom surface facing an opposite direction of the light emitting surface. The light incident surface defines a plurality of V-shaped grooves perpendicular to the light emitting surface. Light rays produced by a light source are emitted into the light guide plate via the light incident surface, the light rays are reflected at the bottom surface and are then emitted out from the light emitting surface of the light guide plate. However, when the light source is a point light source, a plurality of dark areas or brightness areas are generated unavoidably adjacent the light incident surface, thus, decreasing optical uniformity.

Therefore, a new light guide plate and a backlight module using the same are desired in order to overcome the above-described shortcomings.

### SUMMARY

A light guide plate according to a preferred embodiment includes a light incident surface, a light emitting surface and a bottom surface. The light emitting surface adjoins the light incident surface. The bottom surface faces towards an opposite direction of the light emitting surface. A number of first microstructures and at least a second microstructure are formed on the light incident surface. The second microstructure intersects the first microstructures.

A backlight module according to another preferred embodiment includes a light source and a light guide plate having a light incident surface. The light source is positioned adjacent to the light incident surface of the light guide plate. The same light guide plate described in the previous paragraph is employed in this embodiment.

Other novel features will become more apparent from the following detailed description when taken in conjunction with the accompanying drawings.

### BRIEF DESCRIPTION OF THE DRAWINGS

Many aspects of the light guide plate and the backlight module using the same can be better understood with reference to the following drawings. The components in the drawings are not necessarily drawn to scale, the emphasis instead being placed upon clearly illustrating the principles of the present light guide plate and the backlight module using the same. Moreover, in the drawings, like reference numerals designate corresponding parts throughout the several views.

FIG. 1 is a schematic, isometric view of a light guide plate in accordance with a first embodiment;

FIG. 2 is an enlarged view of a circled portion II of FIG. 1;

FIG. 3 is a schematic, partially isometric view of a light guide plate in accordance with a second embodiment; and

FIG. 4 is a schematic, partially isometric view of a backlight module in accordance with a third embodiment.

### DETAILED DESCRIPTION OF THE EMBODIMENTS

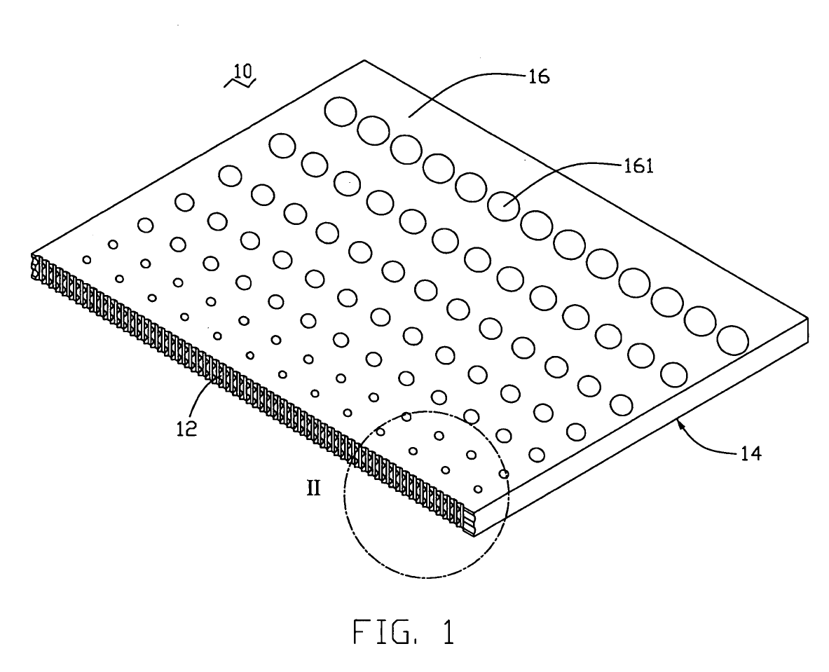

Referring to FIG. 1, a light guide plate 10 according to a first embodiment is shown. The light guide plate 10 is configured for converting point/line light sources into surface light sources in a uniform light energy distribution. The light guide plate 10 is a rectangular sheet, or alternatively may be a generally cuneiform sheet. In the illustrated embodiment, the light guide plate 10 is a rectangular sheet. The light guide plate 10 includes a light incident surface 12 located at a sidewall of the light guide plate 10, a light emitting surface 14 adjoining the light incident surface 12, and a bottom surface 16 facing an opposite direction of the light emitting surface 14.

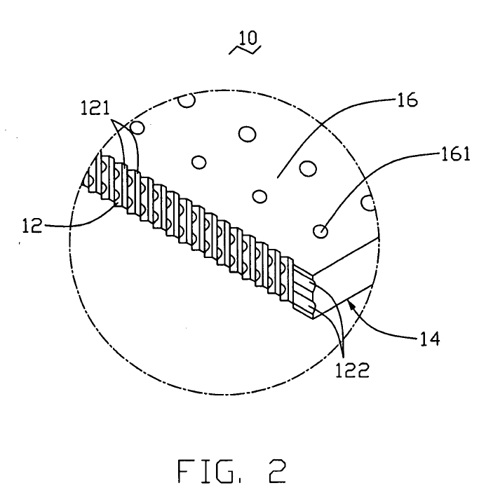

Referring also to FIG. 2, the light incident surface 12 defines a plurality of first microstructures 121 and at least a second microstructure 122. Each first microstructure 121 is substantially a trapezoid-shaped micro groove. The first microstructures 121 are aligned side by side with each longitudinal side extending perpendicularly between the light emitting surface 14 and the bottom surface 16 of the light guide plate 10. Each two adjacent first microstructures 121 substantially form a V-shaped micro protrusion where the adjacent first microstructures 121 join each other. Each second microstructure 122 is substantially an elongated arc-shaped groove that extends in a direction parallel to the light emitting surface 14 on every first microstructure 121. The second microstructures 122 are spaced regularly to each other. In the illustrated embodiment, the number of the second microstructures 122 is two. A depth of each second microstructure 122 is less than that of each first microstructure 121, thus making the second microstructure 122 non-continuous. That is, the second microstructure 122 includes a plurality of non-continuous groove parts formed in the protrusions. The second microstructures 122 intersect the first microstructures 121 at right angles.

In alternative embodiments, the first microstructures 121 may be trapezoid-shaped protrusions, V-shaped grooves, V-shaped protrusions, arc-shaped grooves, arc-shaped protrusions, U-shaped grooves, U-shaped protrusions or other suitable shapes. In alternative embodiments, the first microstructures 121 are spaced and defined on the light incident surface 12. In alternative embodiments, the second microstructures 122 are defined side by side on the light incident surface 12. In alternative embodiments, the second microstructures 122 can intersect the first microstructures 121 at another angles, for example acute angles.

In order to improve the optical uniformity of the light guide plate 10, the bottom surface 16 defines a plurality of third microstructures 161. The third microstructures 161 are substantially patterned dots. In alternative embodiments, the third microstructures 161 may be V-shaped grooves, V-shaped protrusions, U-shaped grooves, U-shaped protrusions or other suitable shapes.

A material of the light guide plate 10 can be selected, for example, from a group consisting of polymethyl methacrylate (PMMA), polycarbonate (PC), and other suitable transparent resin materials.

When the light guide plate 10 is in use, light rays from a light source (not shown) are projected towards the light incident surface 12 of the light guide plate 10. The light rays are then refracted and scattered by the first and second microstructures 121 and 122 of the light incident surface 12 before emitted into the light guide plate 10. The light guide plate 10 redirects the light rays, the light rays are reflected at the bottom surface 16 and finally emitted out from the light emitting surface 14 of the light guide plate 10.

In the above-described light guide plate 10, the first and second microstructures 121 and 122 intersects and locates on the light incident surface 12. The light rays projected towards the light incident surface 12 are scattered by the first and second microstructures 121 and 122. Therefore, the first and second microstructures 121 and 122 can reduce the area of dark areas or brightness areas formed adjacent the light incident surface 12, improving optical uniformity.

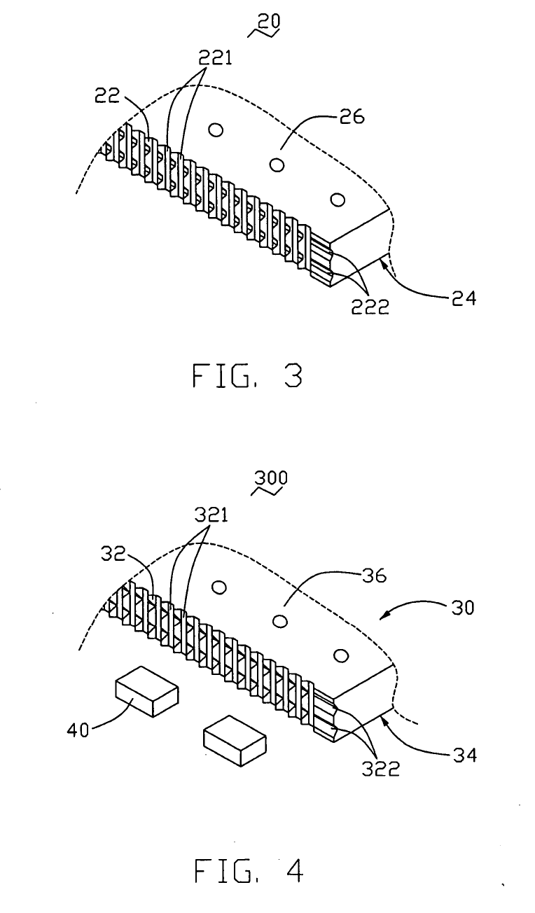

Referring to FIG. 3, a light guide plate 20 according to a second embodiment is shown. The light guide plate 20 includes a light incident surface 22, a light emitting surface 24 adjoining the light incident surface 22, and a bottom surface 26 facing an opposite direction of the light emitting surface 24. The light incident surface 22 defines a plurality of first microstructures 221 and at least a second microstructure 222. The light guide plate 20 is similar in principle to the light guide plate 10 described previously, except that the second microstructure 222 is substantially an elongated trapezoid-shaped groove.

Referring to FIG. 4, a backlight module 300 according to a third embodiment is shown. The backlight module 300 includes a light guide plate 30 and a light source 40. The light source 40 can be selected, for example, from a group consisting of cold cathode fluorescent lamps (CCFLs) and light emitting diodes (LEDs). In the illustrated embodiment, the light source 40 is made up of LEDs. The light guide plate 30 includes a light incident surface 32, a light emitting surface 34 adjoining the light incident surface 32, and a bottom surface 36 facing an opposite direction of the light emitting surface 34. The light source 40 is located adjacent to the light incident surface 32 of the light guide plate 30. The light incident surface 32 defines a plurality of first microstructures 321 and at least a second microstructure 322. The light guide plate 30 is similar in principle to the light guide plate 10 described previously, except that the second microstructure 322 is substantially an elongated V-shaped groove. In alternative embodiments, the second microstructure 322 may be a trapezoid-shaped protrusion, a V-shaped protrusion, an arc-shaped protrusion, a U-shaped groove, a U-shaped protrusion or other suitable shape.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light guide plate, comprising:
a light incident surface;
a light emitting surface adjoining the light incident surface;
a bottom surface facing towards an opposite direction of the light emitting surface; and
a plurality of first microstructures and at least one second microstructure formed on the light incident surface, the second microstructure intersecting the first microstructures.

2. The light guide plate as claimed in claim 1, wherein the first microstructures are aligned side by side with each longitudinal side extending perpendicularly between the light emitting surface and the bottom surface of the light guide plate.

3. The light guide plate as claimed in claim 1, wherein the first microstructures are selected from a group consisting of trapezoid-shaped grooves, trapezoid-shaped protrusions, V-shaped grooves, V-shaped protrusions, arc-shaped grooves, arc-shaped protrusions, U-shaped grooves and U-shaped protrusions.

4. The light guide plate as claimed in claim 1, wherein the second microstructure extends along a direction parallel to the light emitting surface.

5. The light guide plate as claimed in claim 1, wherein the second microstructure is selected from a group consisting of a trapezoid-shaped groove, a trapezoid-shaped protrusion, a V-shaped groove, a V-shaped protrusion, an arc-shaped groove, an arc-shaped protrusion, a U-shaped groove and a U-shaped protrusion.

6. The light guide plate as claimed in claim 1, wherein the number of the second microstructures is equal or more than two, and the second microstructures are defined on the light incident surface regularly and spaced.

7. The light guide plate as claimed in claim 1, wherein a depth of the second microstructure is less than that of each first microstructure.

8. The light guide plate as claimed in claim 1, wherein the second microstructure intersects the first microstructures at right angles.

9. The light guide plate as claimed in claim 1, wherein the bottom surface defines a plurality of third microstructures, and the third microstructures are one of patterned dots, V-shaped grooves, V-shaped protrusions, U-shaped grooves and U-shaped protrusions.

10. A backlight module, comprising:
a light source; and
a light guide plate, the light guide plate including:
a light incident surface, the light source being positioned adjacent to the light incident surface;
a light emitting surface adjoining the light incident surface;
a bottom surface facing towards an opposite direction of the light emitting surface; and
a plurality of first microstructures and at least one second microstructure formed on the light incident surface, the second microstructure intersecting the first microstructures.

11. The backlight module as claimed in claim 10, wherein the light source is selected from a group comprising of a cold cathode fluorescent lamp and a light emitting diode.

12. The backlight module as claimed in claim 10, wherein the first microstructures are aligned side by side with each longitudinal side extending perpendicularly between the light emitting surface and the bottom surface of the light guide plate.

13. The backlight module as claimed in claim 10, wherein the first microstructures are selected from a group consisting of trapezoid-shaped grooves, trapezoid-shaped protrusions, V-shaped grooves, V-shaped protrusions, arc-shaped grooves, arc-shaped protrusions, U-shaped grooves and U-shaped protrusions.

14. The light guide plate as claimed in claim 10, wherein the second microstructure extends along a direction parallel to the light emitting surface.

15. The light guide plate as claimed in claim 10, wherein the second microstructure is selected from a group consisting of a trapezoid-shaped groove, a trapezoid-shaped protrusion, a V-shaped groove, a V-shaped protrusion, an arc-shaped groove, an arc-shaped protrusion, a U-shaped groove and a U-shaped protrusion.

16. A light guide plate comprising:
a light incident surface;
a light emitting surface adjoining the light incident surface;
a bottom surface facing towards an opposite direction of the light emitting surface;
a plurality of micro protrusions formed on the light incident surface, every two adjacent micro protrusions cooperatively defining a first micro groove therebetween; and
a plurality of second micro grooves formed in the micro protrusions.

17. The light guide plate as claimed in claim 16, wherein each micro protrusion extends perpendicularly between the light emitting surface and the bottom surface.

18. The light guide plate as claimed in claim 17, wherein the second micro grooves align with each other along a direction perpendicular to the first micro groove.

19. The light guide plate as claimed in claim 16, wherein the second grooves are selected from the group consisting of V-shaped grooves, U-shaped grooves, trapezoid-shaped grooves, and arc-shaped grooves.
